(19) United States
(12) Patent Application Publication
(10) Pub. No.: US 2014/0182257 A1
(43) Pub. Date: Jul. 3, 2014

(54) Cutting Blade

(71) Applicant: William E. von Rentzell, LaGrange Park, IL (US)

(72) Inventor: William E. von Rentzell, LaGrange Park, IL (US)

(21) Appl. No.: 14/140,310

(22) Filed: Dec. 24, 2013

Related U.S. Application Data
(60) Provisional application No. 61/747,649, filed on Dec. 31, 2012.

(51) Int. Cl. A01D 34/64

(52) U.S. Cl. CPC A01D 34/64
USPC 56/289

(57) ABSTRACT

An improved blade is disclosed. The blade has an elongated member having rotational symmetry about a center axis. The elongated member further has two ends each having a sharpened edge, wherein at least a portion of each sharpened edge comprises a slicing edge configured to intersect a stalk of grass in non-perpendicular relation. The blade is configured so that rotation of the blade causes the slicing edges to come into non-perpendicular contact with the grass, thereby slicing the grass to be mowed.

### CROSS-REFERENCE TO RELATED APPLICATIONS

This application relates to and claims priority from U.S. Provisional Patent Application Ser. No. 61/747,649, filed Dec. 31, 2012.

### FIELD OF THE INVENTION

An improved cutting blade is disclosed. In a preferred embodiment, the improved blade has two-fold rotational symmetry and sharpened, hook shaped cut-outs at the leading edges. These sharpened hook-shaped cut-outs serve to improve cutting efficiency not only by slicing, rather than chopping, through the grass as it cuts, but also by lowering the moment of inertia of the rotating blade and thereby reducing the energy needed to spin the lawn mower blade. The hook-shaped cut-outs may be added to any existing lawn mower blade design. In a second preferred embodiment, the improved blade has upturned sections on the trailing edges. These upturned edges serve to guide grass clippings up and out of the mower.

### BACKGROUND OF THE INVENTION

There is a basic deficiency in the design of rotary mowers. It lies in the blade design and, in particular, in the way in which standard blades attack the grass. The angle of attack is extremely inefficient, as it is more like a chopping action than a slicing action. This can be appreciated when considering cutting with a kitchen knife. Slicing, or stroking the blade edge across the material to be cut, accomplishes the task of cutting with great energy savings over classic chopping, or driving the edge through the material to be cut in a straight downward stroke.

The following patents and published applications illustrate efforts of others to address some of the problems identified and solved by the disclosure herein. As can be seen, these efforts fall short of providing a complete solution to the problems confronted and solved by the instant disclosure.

These references include: U.S. Pat. No. 7,299,612, entitled “Rotary Mower Blade,” issued to Schuyler on Nov. 27, 2007; U.S. Pat. No. 6,470,662, entitled “Multiple Blade Cutting Apparatus for Rotary Lawn Mower,” issued to Burke et al. on Oct. 29, 2002; U.S. Pat. No. 6,415,591, entitled “Lawn mower Blade with Fan Structure for Creating Enhanced Air Movement,” issued to Tylka, Sr. on Jul. 9, 2002; U.S. Pat. No. 5.899,053, entitled “Lawn Mower Blade,” issued to Roth on May 4, 1999; U.S. Pat. No. 5,394,612, entitled “Brush and Weed Cutter Blade,” issued to Wolfington on Mar. 7, 1995; U.S. Pat. No. 5,343,68, entitled “Cutter Blade for a Rotary Cutter,” issued to de Jong on Sep. 6, 1994; U.S. Pat. No. 4,995,228, entitled “Cutting Blade for Rotary Cutting Machinery,” issued to Hladik, Jr. on Feb. 26, 1991; U.S. Pat. No. 4,628,672, entitled “Rotary Cutter,” issued to Jones on Dec. 16, 1986; U.S. Pat. No. 3,447,291, entitled “Detachable Mower Blade,” issued to Guetterman on Jun. 3, 1969; U.S. Pat. No. 3,343,355, entitled “Lawn Mower Blade,” issued to Freedlander et al. on Sep. 26, 1967; U.S. Pat. No. 3,214,896, entitled “Rotary Cutter Blade,” issued to Watkins et al. on Nov. 2, 1965; U.S. Pat. No. 3,022,621, entitled “Blade for Rotary Cutter,” issued to Zavarella on Feb. 27, 1962; U.S. Pat. No. 2,850,862, entitled “Cutting Device,” issued to Asbury on Sep. 9, 1958; U.S. Pat. No. 1,407,417, entitled “Cutter,” issued to Huelves on Feb. 21, 1922; U.S. Design Pat. No. D523,028, entitled “Rotary Blade,” issued to Fitzpatrick on Jun. 13, 2006; U.S. Design Pat. No. D502,185, entitled “Cutter Blade,” issued to Byrne on Feb. 22, 2005; World Intellectual Property Organization Application Publication No. WO 2003 096786 A1, entitled “Rotary Lawn Mower Blade,” published on behalf of Besogne on Nov. 27, 2003.

These references are discussed in greater detail as follows.

U.S. Pat. No. 7,299,612 generally discloses a rotary motor blade which has a rotational mounting structure in its body member to mount the blade to a power driven motor and thereby rotate the blade. The body member includes at least one free end extending outwardly of the mounting structure with the free end having a front leading edge and a rear trailing edge interconnected by a tip. At least a portion of the front leading edge is tapered to comprise a cutting edge. At least one and preferably a plurality of air flow deforming elements such as indentations are formed in the front leading edge and extend inwardly from the exposed outer surface of the front leading edge to disturb air flow along the rotating blade and enhance the creation of vortices which allow the flow to go from the front leading edge to the rear trailing edge. In a preferred practice of the invention, the air flow deforming elements are a plurality of indentations formed in the front leading edge. Each indentation has a blunt (i.e. unsharpened) exposed surface at the front leading edge. Generally, the overall shapes of the leading (sharpened) edges are shown as straight but no overall shape is claimed, except in regard to the airflow deforming elements. (Claims 1, 15; FIGS. 4, 7, 8)

U.S. Pat. No. 6,470,662 generally discloses a blade cutting apparatus for a rotary lawn mower. The blade cutting apparatus is defined by a plurality of blades projecting radially outward from a central hub. Each blade is defined by a first portion and a second portion, the first portion being defined by a first edge and a second edge and the second portion being defined by a third edge and a fourth edge. The first and third edges are each sharpened for enabling each blade to cut grass in two separate locations along the length of each strand of grass. Each blade is further defined by an elongated slot formed therein between the first portion and the second portion for allowing cut grass and debris to pass through each blade. While the cutting edges of the blades are shown as either convexly or concavely curved, only a convexly curved sharpened edge is claimed. (FIGS. 1a, 1b, 2; Claim 1).

U.S. Pat. No. 6,415,591 generally discloses a lawn mower blade for cutting grass with a scything action. The lawn mower blade includes an elongated bar. The bar is adapted to engage a drive shaft of a lawn mower. The bar has a generally arcuate first cutting edge. The first cutting edge extends along a first side edge of the bar proximate a first end of the bar to a distal end of a second side edge of the bar. The bar further has a generally arcuate second cutting edge. The second cutting edge extends along the second side edge of the bar proximate a second end of the bar to a distal end of the first side edge of the bar. While the leading sharpened edge of the blade is arcuate, the Figures show a convexly curved leading sharpened edge (FIG. 1).

U.S. Pat. No. 5,899,053 generally discloses a lawn mower blade with an improved cutting edge to produce a more efficient cutting area. The inventive device includes an elongated blade member, a first scalloped cutting edge region on one end of the blade member, a second scalloped cutting edge region on the other end, a first deflecting fin on the opposite edge of the second scalloped cutting edge region, a second deflecting fin on the opposite edge of the first scalloped cutting edge region, and a mounting means for mounting the blade member to a lawn mower. The new lawn mower blade is designed to increase the surface area of the cutting edge to effectively cut grass more cleanly and evenly even than a conventional rotary lawn mower blade. The leading sharpened edge of the blade is generally straight, but has a series of scallops to increase the cutting area (FIGS. 1, 3, 5).

U.S. Pat. No. 5,394,612 generally discloses a cutter blade which has a body portion with a central attaching hole for removable attachment to an output end of a powered tool. The blade has a pair of oppositely extending ends with beveled cutting edges on their leading edges. The body and end portions of the blade are curved upwardly for increasing the efficiency in the cutting operation of the blade. It is preferred that the radius of curvature of the blade be approximately 30 inches and that the sharpening bevels on the leading edges extend from a point adjacent the mid-point of the blade to the tips of the blade. The cutting edges are progressively narrower from the mid-point to the tips for increased cutting efficiency and blade strength. The cutter blade also has clearance bevels on the lower surface thereof at the trailing edges of the end portions. These clearance bevels extend from an inner area of the body portion short of the mid-point of the blade to the respective tips. The cutting edges are generally convexly curved (FIGS. 1, 2, 4).

U.S. Pat. No. 5,343,681 generally discloses a cutter blade for use on a rotary cutter of the tractor drawn type. The cutter blade of the invention has a convexly curved cutting edge with the section including the cutting edge being off-set with respect to the section where the blade is mounted on its blade carrier. The ratio of the radius of the circle and the length of the cutting section is between 2:1 and 15:1. The ratio of the overall flat bar length to the length of the cutting section may be between 2:1 and 4:1, whereas the ratio of the overall flat bar length to the flat bar width may be approximately 5:1. Still further, the thickness of the flat bar may be between 5 mm and 15 mm. The use of such cutter blades on a rotary cutter improves cutting efficiency, provides for an increased blade life and reduces the power requirements of the rotary cutter with which the blades are associated (FIGS. 2, 3, 4; Claim 1).

U.S. Pat. No. 4,995,228 generally discloses a rectangular metallic plate cutting blade having an opening at the center thereof for attaching the plate to a rotary power shaft. A pair of trapezoidally-shaped cutting recesses is cut into the leading edges of the blade. The edges of the plate defining the cutting recesses are beveled to provide sharp cutting edges. The several cutting edges are individually straight but collectively function to provide an improved cutting action being achieved through a gathering and slicing action. A turbulence flange extends upwardly from the trailing edge of the metallic plate on the opposite side of the plate from each of the trapezoidally-shaped cutting recesses. Each of these turbulence flanges is from about 1.0 to about 1.5 times as long as the width of the trapezoidally-shaped recess with which it is aligned across the blade, and defines an angle of from about 35° to about 55° with respect to the major plane of the rectangular plate (claim 1; FIGS. 1, 2).

U.S. Pat. No. 4,628,672 generally discloses an improved cutter that finds principal utility in, but is not limited to, lawn mowers of the type in which a cutter blade is rotated about an upright axis by a power source such as an electric motor, internal combustion engine, etc. The disclosed improvement involves a blade that produces a slicing rather than a shearing action, accomplished by a blade design having diametrically opposed end portions, each sharpened to provide a convexly curved slicing edge that is directed from a leading edge portion to a trailing edge portion, thus providing a blade of increased efficiency and requiring lower consumption of horsepower. The slicing edges may also be combined with conventional impact cutting edges. Further, the slicing edge is fashioned or configured to occur as a minimum within the radial distance from the outermost extremities of the blade an amount equal to the maximum exposure of the rotating blade to uncut grass that is encountered with each revolution of the blade as the mower is moved through the grass in a plane parallel to the plane of blade rotation. This radial distance can be defined by a formula relating the radial distance to: the travel velocity of the mower, the number of cutting ends on the blade and revolutions per minute of the rotating blade (Column 1, lines 25-53; FIGS. 1-6).

U.S. Pat. No. 3,447,291 generally discloses a cutter blade for removable disposition within a socket provided in the cutter arm or blade support of agricultural equipment designed for mowing, which blade is provided with female portions for reliably engaging cooperating male members within the socket. At its outer end, the operational portion of blade A is curved forwardly for enhancing the cutting action by direction of the grass or grain to be cut. This results in a slightly concave cutting surface (Column 2, lines 71-71; Column 3, line 1; FIGS. 1, 2).

U.S. Pat. No. 3,343,355 generally discloses an improvement over prior invented lawn mower blades in that the same curved shape is retained, but at the same time the cutting arms of the blade are also curved in a plane at right angles to the shaft, somewhat in the shape of a scimitar. The blade terminates in two arms which are curved oppositely from each other in a plane at right angles to the shaft, terminating in rounded tips. It has been found that this shape enhances the cutting action of the blade by permitting the cutting surface to strike the blades of grass at an angle, thus providing a slicing action. The cutting edge of the blade is curved convexly. The blade is manufactured entirely of a flexible urethane elastomer material (Column 2, lines 6-10; Column 2, lines 38-40, FIG. 3; Claims 1 and 4).

U.S. Pat. No. 3,214,896 generally discloses a rotary cutting blade which has a leading edge which is indented by a plurality of semi-circular hollow ground cutting edges, the adjacent semi-circular cutting edges being spaced by unindented portions of the leading edge (Column 1, lines 21-24; FIG. 1).

U.S. Pat. No. 3,022,621 generally discloses a rotary blade which cuts by forming an indented cutting edge or edges on the side of the blade at an angle greater than 90° to the direction of rotation of the blade. The cutting edge indentations are grouped in a straight line alignment across the cutting path (Column 1, lines 49-53; Column 2, lines 29-30; FIGS. 1 and 3).

U.S. Pat. No. 2,850,862 generally discloses an invention which relates to cutting devices, and is particularly concerned with a cutter blade and an arrangement for supporting the cutting blade on a rotary holder therefor. It is also an object of the invention to provide a swingable type cutter element for lawn mowers or lawn edgers, or the like, in which a sickle cutting action is had thereby improving the cutting efficiency of the cutting element. The outer end of the longer leg 15 of the cutting element is concave in the direction of rotation of holder 10 and the edge of the concave portion is sharpened as indicated at 30, so as to provide for a sickle cutting action (Column 1, lines 15-18 and lines 38-42; Column 2, lines 41-44; FIG. 3).

U.S. Pat. No. 1,407,417 generally discloses improvements in cutters for use in machines for picking up, cutting and plowing under cane straw and the like, the object of the invention being to effect improvements in the construction of the cutters, especially as to the shape of the arms thereof to adapt the cutters for picking up the straws or stalks to be cut, and also as to the construction and arrangement of the cutter blades. Each cutter blade corresponds in shape with the cutter arm to which it is attached, and has a curved hook-shaped outer end (Column 1, lines 10-19; Column 2, lines 89-92; FIGS. 1, 2, 4).

U.S. Design Pat. No. D523,028 generally discloses a design for a rotary cutter. The rotary cutter has 3 curved arms. One edge of each arm is convexly curved and one edge of each arm is concavely curved (FIGS. 1, 2, 4).

U.S. Design Pat. No. D502,185 generally discloses a design for a cutter blade. The blade has two arms. One edge of each arm is straight and the other is convexly curved (FIGS. 1-3).

PCT Appl. Publication No. WO 2003 096786 A1 generally discloses a lawn mower blade or the like consisting of a rectangular elongated and flattened plate (2) including in its center a bore (3) bordered on either side with holes (4) for its being fixed to a rotating drive shaft, said blade comprising a leading edge (7), a trailing edge (8) and a raised part (9) located proximate each end of the blade, while each leading edge (1) and trailing edge (8) has, relative to a horizontal, plane containing the plate (2), a chamfered profile (6) which is provided with an angle (β) ranging between 0 and 30 degrees and in that the chamfered profile (6) includes a tapered terminal tip (10) whereof the land thickness d ranges between 0.1 and 0.5 millimeters. The leading edge is shown as straight or as having a concave cut-out (FIGS. 1, 4).

Thus, a problem associated with blades that precede the present disclosure is that they do not provide, in combination with the other features and advantages disclosed herein, a blade that slices, rather than chops, through grass to be cut.

Still a further problem associated with blades that precede the present disclosure is that they do not provide, in combination with the other features and advantages disclosed herein, a blade that cuts efficiently and is therefore especially suited for use in battery powered lawn mowers, which tend to have limited use time between charges and thus will more freely benefit from extended run times with a more efficient blade design.

Another problem associated with blades that precede the present disclosure is that they do not provide, in combination with the other features and advantages disclosed herein, a blade that has a reduced moment of inertia, thus requiring less energy to rotate the same at a given rate of speed.

There is a demand, therefore, to overcome the foregoing problems while at the same time providing an improved cutting blade that can be readily manufactured and maintained.

### SUMMARY OF THE INVENTION

In a preferred embodiment, the rotary lawn mower blade disclosed herein provides an improved cutting edge. The improved cutting edge may be applied to any existing typical lawn mower blade. The improved cutting edge comprises a sharpened, arc-shaped cut-out at the outer end of the rotating blade that cuts grass with a slicing, rather than chopping motion. This slicing motion not only is more efficient, resulting in lower power consumption by a rotary lawn mower using the improved blade, but also can be sharpened to a more keen edge than prior art blades. This keener, hollow ground edge, combined with the slicing action, results in the grass being cut cleanly, rather than torn off. The cut edges of the grass thus are not as prone to die and turn brown as is the case with prior art blades that chop, rather than slice, the grass.

Further, the disclosed improved blade, having cut-outs near its outer ends, has a reduced mass at its outer ends, furthest from its axis of rotation, thus reducing the moment of inertia of the blade compared to a blade without the cut-outs. The lower moment of inertia of the blades is anticipated to contribute to a lower power consumption during lawn mowing, making the improved blade especially suited for use in electric, battery-operated lawn mowers where reduced power consumption translates to additional square footage of lawn that can be mowed per battery charge.

The following disclosure provides an improved rotary lawn mower blade that provides the foregoing advantages while at the same time is economical to manufacture.

### BRIEF DESCRIPTION OF THE DRAWINGS

In the detailed description that follows, reference will be made to the following figures:

FIG. 1 illustrates a prior art cutting blade adapted for use on a lawn mower;

FIG. 2 is a perspective view of a preferred embodiment of an improved cutting blade;

FIG. 3 is a front view of the preferred embodiment shown in FIG. 2;

FIG. 4 is a front view of a second preferred embodiment;

FIG. 5 is a cross-sectional view of the cutting edge of the preferred embodiment shown in FIG. 2;

FIG. 6 is a schematic of a section of the preferred embodiment shown in FIG. 2;

FIG. 7 is perspective view of a second preferred embodiment of an improved cutting blade; and

FIG. 8 is a cross-sectional view of a portion of the second preferred embodiment shown in FIG. 7.

### DETAILED DESCRIPTION OF PREFERRED EMBODIMENTS

Introduction:

There is a basic deficiency in the design of rotary mowers. It lies in the blade design and, in particular, in the way in which standard blades attack the grass. The angle of attack is extremely inefficient, as it is more like a chopping action rather than a slicing action. This can be appreciated when considering work with a kitchen knife. Slicing, or stroking the blade edge across the material to be cut, accomplishes the task of cutting with great energy savings over classic “chopping,” or driving the edge through the material to be cut in a straight downward stroke.

A chopping motion is the cutting approach used by all current rotary mowers. Their cutting edges are driven into the material, much as one drives an axe into a tree trunk. This inefficiency is demonstrated in analogous fashion by two different mandolin slicers; one having a blade edge extending perpendicular to the stroke of the material across the slicer and the other having a blade edge extending about 30 degrees off of perpendicular to the stroke of the materials across the slicer. The angled blade is more efficient.

Just as a vegetable in the kitchen, grass can be cut much more efficiently if the blade is stroked across the grass, the cutting edge attacking it at an angle to the radius of the spinning blade rather than parallel to the radius. This cutting technique in mowing grass is demonstrated in the use of the classic scythe. A skilled user mowing with a scythe can cut with a smooth, efficient, manual stroke. According to Wikipedia, the scythe dates back to about 500 B.C.

While energy savings would be realized in both a gasoline-powered mower and a battery-powered mower, the range of mowing ability in gasoline-powered mowers is typically adequate for most consumers' needs. Conversely, the battery charge capacity for cordless battery-powered mowers is too limited at present for many homeowners. Consequently, in a most preferred embodiment, it is anticipated that the technology disclosed herein will be more readily applied for use on a battery-powered mower. The improved cutting edge disclosed herein may be adapted to any existing lawn mower blade design.

The simplest method of adapting the current disclosure to a rotary mower is to take an existing mower blade design and modify the cutting edge area as follows. The cutting edge area would be modified from a straight line into an arc that brings the line of the cutting edge nearest the tip as close to parallel to the circle the tip of the blade makes spinning in the deck of the mower, and progressively arcing back to the pre-existing edge cut nearer the center of the length of the blade. Most rotary mower blades have an upward bend of the trailing edge of the blade end to propel the grass clippings upward into the deck and out through the chute to the bagging attachment or discharge chute. Accommodations either in the scythe arc modification or the clippings control bend may variously be included, depending on the details of the specific blade to be modified with the disclosed improved cutting edge.

Further, the arc-shaped cut-outs at the blade's ends reduce mass furthest from the blade's axis of rotation, thus reducing significantly the moment of inertia of the spinning blade. This reduces the energy needed to accelerate the blade to a set rotational speed, further contributing to the efficiency of the improved cutting blade.

In a preferred embodiment, a 14-inch battery-powered electric mower (Neuton EM 4.1 battery electric mower manufactured by Neuton, Inc. Vergennes, Vt.) is used. Developmental data was acquired on a 120 foot by 60 foot city/suburban lot. Allowing for buildings, pavement and planting beds, the lot provided about 3000 square feet of lawn. This is typical of suburban homes in the United States, particularly those that are proximate to major cities such as New York or Chicago.

Comparing the conventional, but sharpened, blade to the prototype of the current disclosure, the mower was operated over two (as near as possible) identical patches of lawn, each having a thick growth of grass on them. The sound of the mower motor with the prototype blade (with the as yet un-hardened edge) was much less complex, of a significantly higher dominant pitch and was more constant throughout mowing the thicker patches of grass, as compared to the sound of the mower using the standard blade doing the same work. It is anticipated that the higher pitch, less complex, more constant sound observed during mowing through relatively heavy material indicates that less load is placed on the motor using the prototype blade than using the conventional blade during the accomplishment of similar mowing work. It is further anticipated that an even greater reduction in operational load will be attainable upon hardening and re-dressing, or sharpening with an extra fine grit stone, the prototype's cutting edge to the greater, more durable keenness it will allow.

Description of Figures:

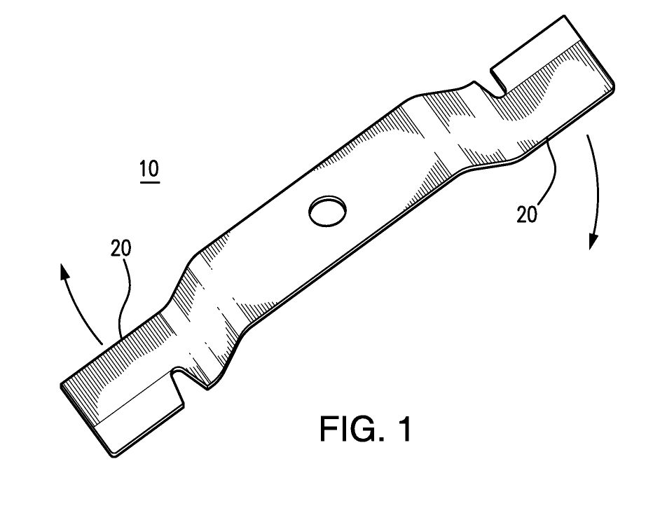

A typical, prior art, rotary lawn mower blade 10, as shown in FIG. 1, cuts grass with a chopping motion. When the blade is rotated, the cutting surfaces 20 move rotationally and meet the grass in a perpendicular relation. Consequently, the cutting surfaces 20 are driven into the grass, much as one drives an axe into a tree trunk. This inefficiency is demonstrated in analogous fashion by two different mandolin slicers; one having a blade edge extending perpendicular to the stroke of the material across the slicer and the other having a blade edge extending about 30 degrees off of perpendicular to the stroke of the materials across the slicer. The angled blade is more efficient because the blade is sliced across the grass, resulting in the cutting edge attacking it at an angle to the radius of the spinning blade rather than parallel to the radius.

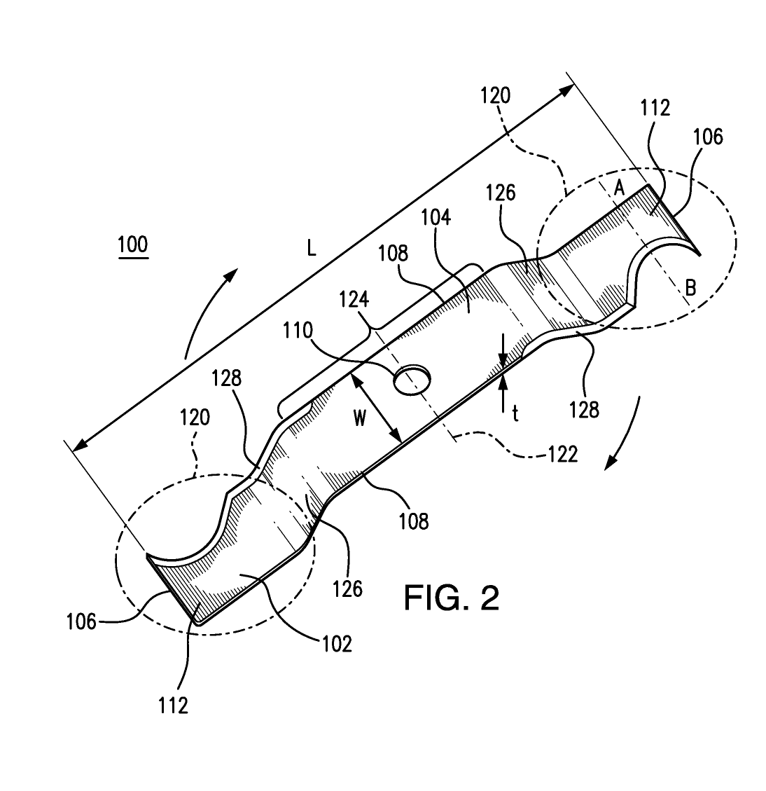

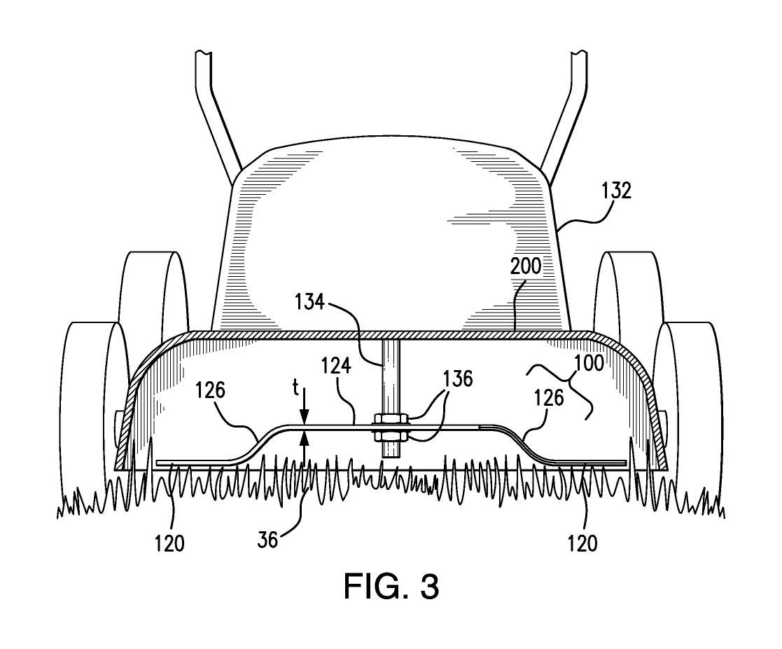

A first preferred embodiment of a cutting blade 100 modified according to the current disclosure adapted for use on a lawn mower is shown in FIG. 2. The blade 100 is comprised of any suitable metal, e.g. steel or the like. The blade 100 is configured to be mounted under the deck 200 of a rotary lawn mower as shown in in FIG. 3.

Referring now again to FIG. 2, the blade 100 comprises an elongated member 102 having nominal length L, nominal width W and nominal thickness t. A typical length L may be between 14 and 24 inches. A typical width W may be between 2 and 4½ inches. A typical thickness t may be between 1/10 inch and ¼ inch. Each of L, W and t may vary within a given blade 100, as uniformity is not required. However, rotational symmetry is required for rotational balance.

The blade 100 has a top side 104, which is understood to be the side facing lawn mower deck 200. Blade 100 has ends 106 and sides 108. A mounting hole 110 is centrally placed equidistant from the ends 106 and the sides 108 of blade 100 and must be positioned at the center of mass of the blade 100. The direction of rotation of the blade 100 is shown by the arrows and the blade 100 possesses two-fold rotational symmetry about the mounting hole 110.

Looking in more detail at FIG. 2, it can be seen that blade 100 has a modified cutting region 120 at each terminus 112, with a mounting area 124 in the central portion of the blade 100.

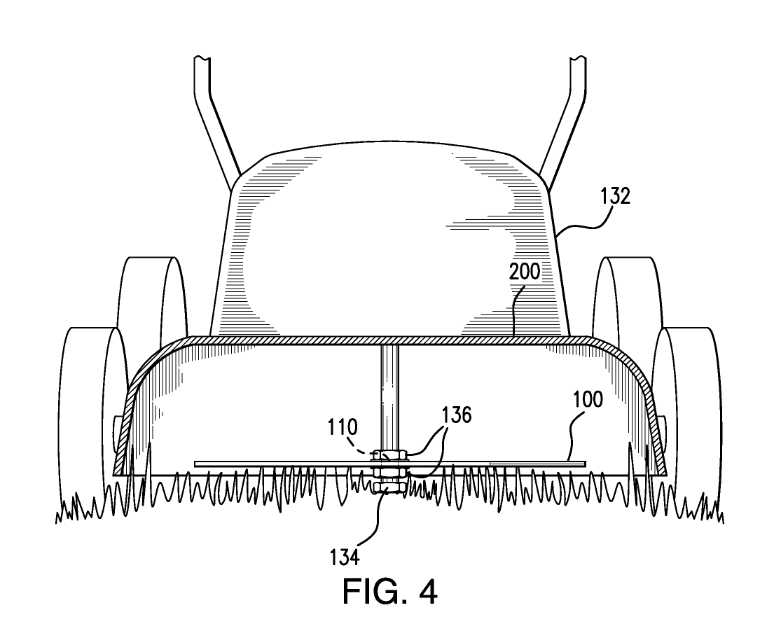

The modified cutting regions 120 are flat and co-planar to each other. Although not necessary, as drawn the cutting regions 120 are parallel to but below (relative to the mower deck 200) the mounting area 124. Thus, because the mounting area 124 can either be flat (as shown in FIG. 4) flat or raised (as shown in FIG. 3), the mounting area 124 is preferably between 0 and ¾ inch above the modified cutting regions 120. More preferably, the mounting area 124 is between 0 and ⅝ inch above the modified cutting regions 120. In a most preferred embodiment, the mounting area 124 is between 0 and ½ inch above the modified cutting regions 120.

Shoulder regions 126 are interposed between the mounting area 124 and the modified cutting regions 120, and are sloped as necessary to provide a 1:2 rise, i.e. the horizontal component of the shoulder region preferably is about twice the length of the vertical component of the rise, and are preferably twice as long as the height of the raised mounting area.

Blade 100 also has two sharpened cutting edges 128. These sharpened cutting edges 128 are positioned so that, in operation, when the blade 100 rotates in the direction indicated by the arrows, the sharpened cutting edges 128 are at the leading edges of the blade 100.

On a modified 14-inch Neuton blade prototype, the total length of each cutting edge 128 is about 4 inches. On a conventional, 21-inch long Sears mower blade, the total length of each cutting edge is about 7 inches. As shown, however, a curved slicing region of the cutting edge 128 is provided and is preferably between 2 and 2½ inches long. In a most preferred embodiment, the curved slicing region of the cutting edge 128 is 2¾ inches long.

As shown in front cutaway in FIG. 3, the mounting hole 110 provides an aperture through which the blade 100 can be removably secured in drivable relation to a lawn mower engine or motor 132. The lawn mower engine or motor 132 rotates the blade 100. This removable securement can be achieved through traditional apparatus such as bolt 134 and nuts 136. The mounting hole 110 may be of any suitable size to accept the bolt 134 and the mounting hole 110 is understood to be the axis about which blade 100 rotates. It is understood that other mounting arrangements are possible; for instance, two symmetrically located mounting holes may be used to mount the blade 100 to an engine or motor 121, but the blade 100 would still rotate about its center of mass.

Also shown in FIG. 3, the mounting area 124 and shoulder regions 126 combine to ensure that as blade 100 is rotated by the engine or motor 132 around the mounting hole 110, the modified cutting region 120 is below and clear of the lawn mower deck 200 as the blade 100 rotates and cuts grass 36. Of course, this arrangement is only one example of a construction by which the lawn mower blade 100 is maintained clear of the lawn mower deck 200 as the blade 100 rotates. For example, the blade 100 may not include distinct shoulder regions 126 where the mounting area 124 and the modified cutting region 120 are coplanar (i.e. the rise is 0 inches). Thus, the blade 100 may be mounted onto a lawn mower engine or motor 132 by bolt 134 and nuts 136, as shown in FIG. 4. It is understood here as well, that a single bolt is only one of the possible arrangements by which the blade 100 can be secured in drivable relation to the motor or engine 132.

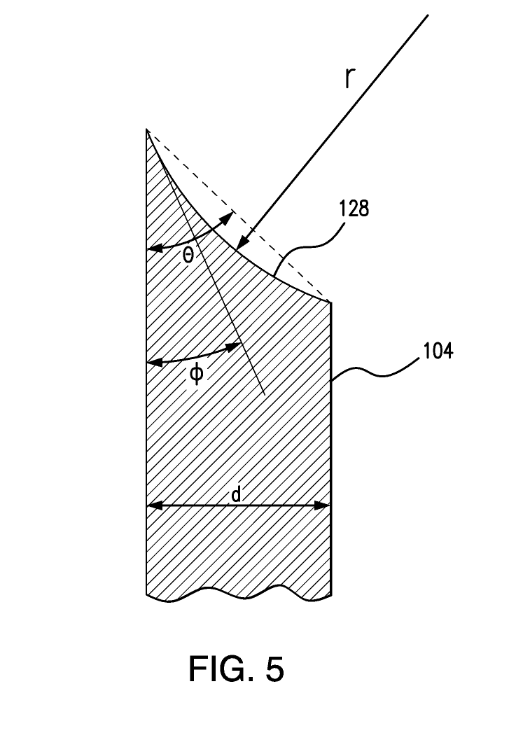

FIG. 5 illustrates a cross-sectional view of blade 100 taken along line A-B in FIG. 2. FIG. 5 shows in larger view the profile of a preferred shape of sharpened cutting edge 128. The sharpened cutting edge 128 is hollow ground, with the concave side oriented towards the top side 104 of the blade 100. The included angle θ of the hollow ground sharpened cutting edge 128 is preferably between 20 and 30 degrees. The preferred edge angle φ is between 0 and θ degrees, and more preferably 15 degrees.

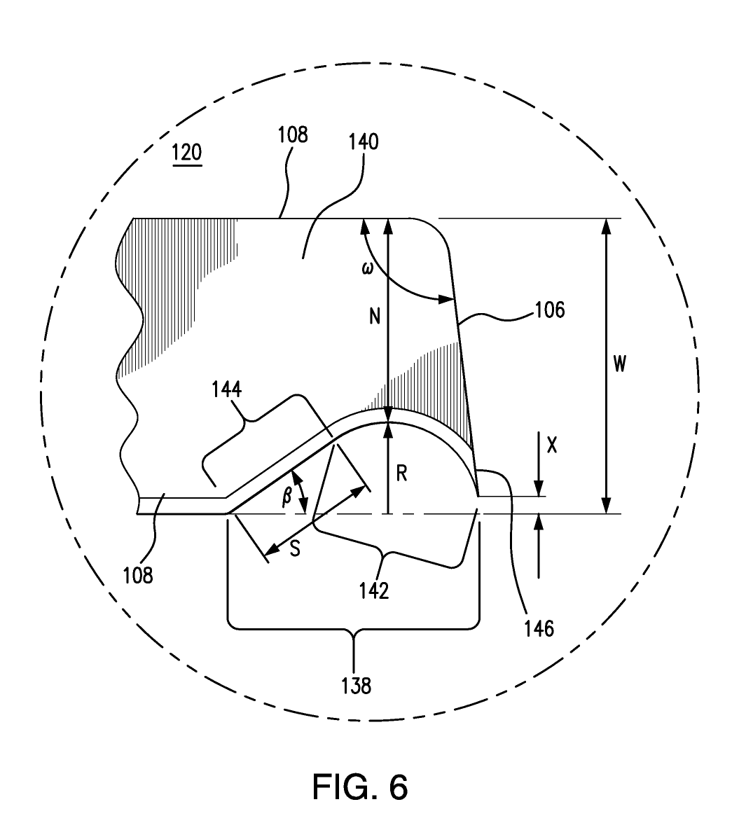

Referring now to FIG. 6, the sharpened cutting edge 128 that extends into the modified cutting region 120 is shown in more detail. Terminus 140 of sharpened cutting edge 128 extends into modified cutting region 120 and further has a hook-shaped slicing edge 138. The hook-shaped slicing edge 138 comprises an arc-shaped edge 142 and an angled straight edge 144. The arc-shaped edge 142 is located at the outer terminus of the blade 100 and is adjacent the angled straight edge 144, which is positioned closer to the mounting hole 110 in the center of blade 100. The arc-shaped edge 142 has a radius of curvature R. Radius R is preferably between ⅝ and 1¼ inches, and more preferably ¾ inches. Radius R extends into the modified cutting region 120 such that the narrowest part of the modified cutting region 120, N, is between 55 and 85 percent of W and most preferably 70 percent of W.

The angled straight edge 144 is positioned at an angle β as it extends tangentially from the arc-shaped edge 142. Preferably β is between 5 degrees and 20 degrees, and more preferably is between 10 degrees and 15 degrees, as measured from the side 108 of blade 100. Further, the arc-shaped edge 142 extends between 120 and 150 degrees of arc, and preferably extends 135 degrees. The angled straight edge 144 has length s which depends on distance needed to intersect both the side 108 of blade 100 and the arc-shaped edge 142. The length s is preferably between 0.5 and 1 inches, and more preferably 0.8 inches. Accordingly, the total length of the hook-shaped slicing edge 138 is between 2 inches and 2½ inches and most preferably is 2¼ inches.

Also shown in FIG. 6, a tip 146 of the arc-shaped cutting edge 138 is provided. The radius of arc-shaped edge 142 is placed such that the tip 146 is formed from the intersection of the arc-shaped cutting edge 138 with the outer end 106 of blade 100. As illustrated, the tip 146 is shown as a sharp point, but it is expected that a production model would be preferably slightly rounded, in order to provide more strength.

The outer end 106 of the blade 100 intersects the side 108 of the blade 100 at angle ω, as shown in FIG. 6. The angle ω is preferably 100 degrees and ranges from 90 degrees to 110 degrees.

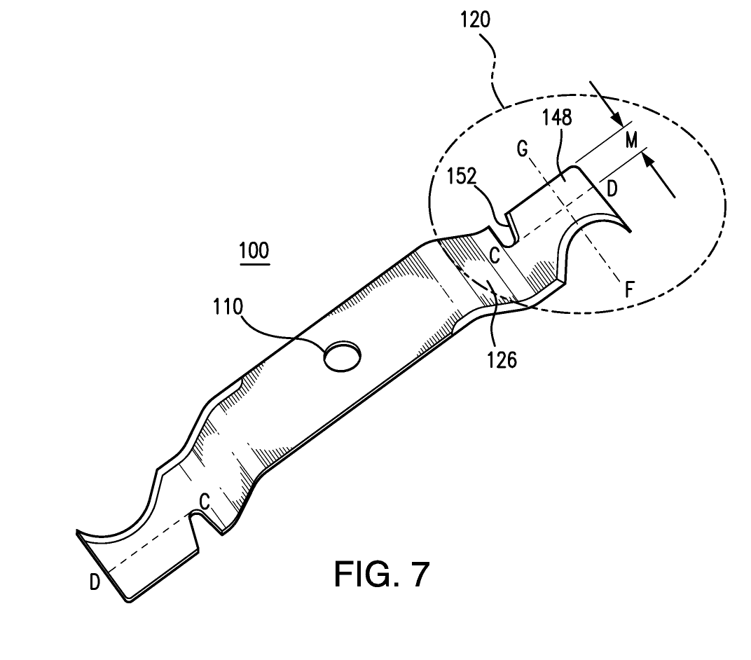

A second preferred embodiment of the blade 100 is shown in perspective view in FIG. 7. Like the first embodiment of the blade 100, this embodiment also possesses two-fold rotational symmetry about the mounting hole 110. This second embodiment is similar to the first embodiment, except that the modified cutting region 120 further comprises an upturned section 148 and a notch 152, both located on the trailing edge of blade 100. The notch 152 is located at the intersection of shoulder region 126 and modified cutting region 120. The upturned section 148 is bent upward towards the top 104 of blade 100 at an angle α, along the line C-D shown in FIG. 7. Angle α is preferably 10 degrees, but may range from 5 degrees to 15 degrees. The line C-D runs substantially parallel to the centerline of blade 100 and is distance M from the trailing edge of blade 100. Distance M is preferably 30% of width W, but may range from 25% to 35 percent of W. The notch 152 is of depth M, such that the upturned section 148 may be bent independently of the shoulder region 126, ensuring that the remaining section of modified cutting region 120 remains coplanar with raised mounting area 124.

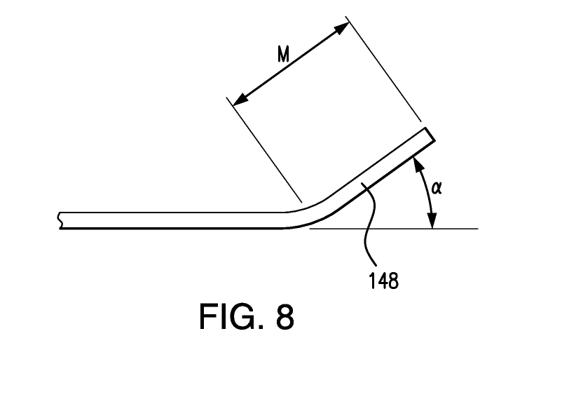

FIG. 8 is a cross section of FIG. 7, taken along the line E-F in FIG. 7, showing the angle α and distance M. Upon rotation, upturned section 148 provides airflow to direct grass clippings upwards and away from blade 100.

in operation, the lawn mower engine or motor 132 will spin the blade 100 at a typical rotational rate of 2000 to 4000 revolutions per minute. Assuming that the lawn mower is propelled forward at 3 feet per second and that the lawn mower blade is spinning at 3000 revolutions per minute, the lawn mower travels forward 0.05 feet or 0.6 inches per revolution. Thus, it is believed that the blade 100 slices, rather than chops, the grass, and that the hook-shaped slicing edge 138 gathers grass as it is sliced. Further contributing to the efficiency of the improved modified blade, the hook-shaped cut-outs at the blade's ends reduce the mass furthest from its axis of rotation, thus reducing the moment of inertia of the blade.

As thus described, an improved lawn mower blade is disclosed. The improved blade possesses two-fold rotational symmetry about a center mounting hole. The improved blade comprises a hook shaped slicing edge at the leading edge of its outer ends. The hook-shaped slicing edge comprises an arc shaped edge at the very outer terminus of the leading edge, connected to an angled straight edge. The angled and curved shape of the cutting edges contributes to a slicing, rather than chopping motion through the grass as the blade spins. This slicing motion improves the efficiency of the blade as it cuts grass, so that less energy is used. The hook-shaped cut-out also reduces the mass of the improved blade furthest from its axis of ration, reducing the moment of inertia and thus the energy needed to spin the blade. Further, the cutting edge of the improved blade is hollow ground and therefore is sharper than a straight-ground blade which also contributes to the efficiency of the improved blade. The improved blade may further comprise an upturned section on the trailing edges of the slicing section, which directs grass clippings up and away from the blade. It is anticipated that this hook-shaped slicing edge can be applied to any existing lawn mower blade design.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

I claim:

1. A blade comprising:
an elongated member having length L, width W and thickness t, the elongated member having rotational symmetry about a center axis;
the elongated member further having two ends each having a sharpened edge, wherein at least a portion of each sharpened edge comprises a slicing edge configured to intersect a stalk of grass in non-perpendicular relation;
the blade configured for securement to a mower configured to position the blade proximate to grass to be cut and having a rotational drive that rotates the blade about the center axis in a rotational direction;
whereby rotation of the blade causes the slicing edges to come into non-perpendicular contact with the grass, thereby slicing the grass to be mowed.

2. The blade of claim 1, each slicing edge further comprising a hook-shaped outer portion having an outwardly positioned arc-shaped edge region having a radius of curvature R and extending into the width of the elongated member so that a narrowest part of the elongated member is N percent of W.

3. The blade of claim 1, each slicing edge further comprising an angled straight edge region having a length s and extending to form an angle β relative to the rotational direction.

4. The blade of claim 1, each slicing edge further comprising:
a hook-shaped outer portion having an outwardly positioned arc-shaped edge region having a radius of curvature R; and
an angled straight edge region extending inwardly from the hook-shaped outer portion in tangential relation therefrom;
the arc-shaped edge region extending into the width of the elongated member so that a narrowest part of the elongated member is N percent of W;
the angled straight edge region having a length s and extending to form an angle β relative to the rotational direction.

5. The blade of claim 4, the elongated member further comprising:
a central mounting area located symmetrically about the center axis; and shoulder regions each (a) interposed between the central mounting area and a slicing region and (b) being angled relative to the central mounting area so that the slicing edges are parallel to the central mounting area, whereby the slicing edges are a distance D below the central mounting area.

6. The blade of claim 5 wherein:
L is between 14 and 24 inches,
W is between 2 and 4½ inches,
N is between 55 and 85 percent of W,
t is between 1/10 inch and ¼ inch,
each sharpened edge is between 4 and 8 inches long,
R is between ⅝ and 1¼ inches,
s is between ½ and 1 inch,
β is between 5 and 20 degrees,
the total length of the hook-shaped outer portion is between 2 and 2½ inches, and
D is between 0 and ¾ inches.

7. The blade of claim 4 wherein the elongated member is comprised of steel.

8. The blade of claim 5 wherein the elongated member is comprised of steel.

9. A blade comprising:
an elongated member having a length L, width W and thickness t, the elongated member having rotational symmetry about a center axis;
L being between 14 and 24 inches, W being between 2 and 4½ inches and t being between 1/10 inch and ¼ inch;
the elongated member further having two ends each having a sharpened edge, wherein at least a portion of each sharpened edge comprises a slicing edge configured to intersect a stalk of grass in non-perpendicular relation;
each slicing edge further comprising a hook-shaped outer portion having an outwardly positioned arc-shaped edge region having a radius of curvature R and an angled straight edge region extending inwardly from the hook-shaped outer portion in tangential relation therefrom;
the arc-shaped edge region extending into the width of the elongated member so that a narrowest part of the elongated member is N percent of W;
the angled straight edge region having a length s and extending to form an angle β relative to the rotational direction;
the blade configured for securement to a mower configured to position the blade proximate to grass to be cut and having a rotational drive that rotates the blade about the center axis in a rotational direction;
whereby rotation of the blade causes the slicing edges to come into non-perpendicular contact with the grass, thereby slicing the grass to be mowed.

10. The blade of claim 9 wherein the elongated member is comprised of steel.

11. The blade of claim 10 wherein N is between 55 and 85 percent of W.

12. The blade of claim 10 wherein R is between ⅝ and 1¼ inches.

13. The blade of claim 10 wherein s is between ½ and 1 inch.

14. The blade of claim 10 wherein β is between 5 and 20 degrees.

15. The blade of claim 10 wherein the total length of the hook-shaped outer portion is between 2 and 2½ inches.

16. The blade of claim 10 wherein D is between 0 and ¾ inches.

17. A steel blade comprising:
an elongated member having a length L, width W and thickness t, the elongated member having rotational symmetry about a center axis;
L being between 14 and 24 inches, W being between 2 and 4½ inches and t being between 1/10 inch and ¼ inch;
the elongated member further having two ends each having a sharpened edge, wherein at least a portion of each sharpened edge comprises a slicing edge configured to intersect a stalk of grass in non-perpendicular relation;
each slicing edge further comprising a hook-shaped outer portion having an outwardly positioned arc-shaped edge region having a radius of curvature R and an angled straight edge region extending inwardly from the hook-shaped outer portion in tangential relation therefrom;
the arc-shaped edge region extending into the width of the elongated member so that a narrowest part of the elongated member is N percent of W;
the angled straight edge region having a length s and extending to form an angle β relative to the rotational direction;
the blade configured for securement to a mower configured to position the blade proximate to grass to be cut and having a rotational drive that rotates the blade about the center axis in a rotational direction;
N being between 55 and 85 percent of W;
R being between ⅝ and 1¼ inches;
s being between ½ and 1 inch;
β being between 5 and 20 degrees;
the total length of the hook-shaped outer portion being between 2 and 2½ inches;
D being between 0 and 34 inches;
whereby rotation of the blade causes the slicing edges to come into non-perpendicular contact with the grass, thereby slicing the grass to be mowed.
